(19) United States
(12) Patent Application Publication
(10) Pub. No.: US 2007/0116105 A1
(43) Pub. Date: May 24, 2007

(54) MULTIPLE RECEIVER RF INTEGRATED CIRCUIT ARCHITECTURE

(76) Inventors: John Philip Tero, Saratoga, CA (US); Hung C. Nguyen, San Jose, CA (US); Cuong Q. Nguyen, San Jose, CA (US)

Correspondence Address: SQUIRE, SANDERS & DEMPSEY L.L.P, PATENT DEPARTMENT, ONE MARITIME PLAZA, SUITE 300, SAN FRANCISCO, CA, 94111-3492, US

(21) Appl. No.: 11/560,342

(22) Filed: Nov. 15, 2006

Related U.S. Application Data
(60) Provisional application No. 60/737,566, filed on Nov. 16, 2005.

(51) Int. Cl. H04L 5/16; H04L 27/08; H04L 1/02

(52) U.S. Cl. 375/219; 375/345; 375/347

(57) ABSTRACT

A receiver has a plurality of antennas, a voltage controlled oscillator (VCO), and a processor. Each antenna is coupled to a receiver channel. The voltage controlled oscillator is coupled to the receiver channels. The processor is coupled to the receiver channels and substantially continuously monitors and merges signals from the receiver channels. All the receiver channels may be integrated on a single circuit such that only a single VCO is required.

### PRIORITY REFERENCE TO PRIOR APPLICATION

This application claims benefit of and incorporates by reference U.S. patent application Ser. No. 60/737,566, entitled “Multiple Receiver RF Integrated Circuit Architecture,” filed on Nov. 16, 2005, by inventors John Tero et al.

### Technical Field

This invention applies generally, but not exclusively, to wideband, intelligent array radio (IAR) architectures and method of use thereof.

### Background

Wireless systems invariably employ a single antenna at each end of a link, e.g., at an access point and at a station (e.g., laptop, PDA, etc.). However, the range of a single antenna can be degraded by several factors such as path loss due to distance, path loss due to objects in the line of sight; environmental changes and signal reflections. Furthermore, if the antenna requires directional flexibility, or a directional capability, it must be initially designed to have a specific directionality window and then mechanically moved to re-align this window.

A wireless system using a single receiver channel together with multiple antennas can overcome some of these problems. For instance in an environment where line of sight is not guaranteed, but signal reflections are always available, performance can be enhanced by using several antennas with different directionality. A wireless link using a single receiver channel could then select the antenna with optimum link performance and connect to it after following an initial link evaluation routine. This type of system is called diversity wireless. However if the signal on the selected antenna degrades significantly then the wireless must perform another link evaluation routine, with possible loss of signal, before normal service can be resumed.

Accordingly, a new system and method are needed that overcome the above-mentioned deficiencies.

### SUMMARY

Embodiments of the invention provide a method for extending and maintaining wireless coverage using an antenna array with each antenna permanently connected to a separate receiver channel. All receiver channels are incorporated onto the same integrated circuit in order to maintain channel-to-channel matching characteristics over variations of temperature and manufacturing process spreads and all remain active whilst the system is receiving signals. The advantage of this form of multiple receiver channel wireless system is that the signals from all receiver channels, once converted to a digital format, can be combined using a suitable digital signal processing algorithm to achieve improved signal coverage and reception. The signal combining can be performed on the same, or a separate, integrated circuit. The combining algorithm can employ the ability to individually change the voltage gain in each receiver channel through a Variable Gain Amplifier (VGA) and/or to change the phase shift through each receiver channel by either a virtual phase shift in the DSP or using a multi-phase Voltage Controlled Oscillator (VCO) in the receiver. Such a suitable algorithm can then dynamically combine all signals together to maintain optimum signal reception and extended signal range, whether it is direct line-of-sight or a combination with multi-path reflections, and can introduce directionality into the antenna array to achieve improved signal gain and added security.

In an embodiment, a receiver has a plurality of antennas, a voltage controlled oscillator (VCO), and a processor. Each antenna is coupled to a receiver channel. The voltage controlled oscillator is coupled to the receiver channels. The processor is coupled to the receiver channels and substantially continuously monitors and merges signals from the receiver channels. All the receiver channels may be integrated on a single circuit such that only a single VCO is required.

In an embodiment, a method comprises: receiving a signal at a plurality of antennas, each antenna coupled to a receiver channel, respectively; processing the received signals; and substantially continuously monitoring and merging the processed signals from the receiver channels.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a conventional wireless path with single antennas for both the transmitter and receiver ends of the link;

FIG. 2 is a block diagram illustrating a wireless path with a single antenna for the transmitter end of the link and two antennas for the receiver end of the link for diversity reception;

FIG. 3 is a block diagram illustrating a wireless path according to an embodiment of the present invention;

FIG. 4 is a flowchart illustrating a method of receiving a wireless signal.

### DETAILED DESCRIPTION OF THE ILLUSTRATED EMBODIMENTS

The following description is provided to enable any person having ordinary skill in the art to make use of the invention and is provided in the context of a particular application and its requirements. Various modifications to the embodiment will be readily apparent to those skilled in the art and the principles defined herein may be applied to other embodiments and applications without departing from the spirit and scope of the invention. Thus the present invention is not intended to be limited to the embodiment shown but is to be accorded the widest scope consistent with the principles, features and teachings disclosed herein.

In the description of the drawings some sections of both the transmitter and receiver have been omitted for reasons of clarity. Many wireless systems use a type of modulation known as Quadrature Phase Modulation (QFM) particularly in wide band applications. Any person of ordinary skill in the art will know that this type of modulation requires each transmitter and receiver channel to contain two identical signal paths. One path carries an in-phase signal, called the ‘I’ signal, and the other carries a quadrature-phase signal, called the ‘Q’ signal. In the transmitter channel these two paths are separate and are only combined at the input to the power amplifier (PA in the drawings) that connects to the transmitter antenna. In each receiver channel the combined signal is split into two identical paths after passing through the low noise amplifier (LNA in the drawings) that connects to the receiver antenna.

In the description of the drawings, therefore, only one path is shown for each transmitter and receiver channel. Any person having ordinary skill in the art would recognize that, in embodiments using QFM, there would be two paths in the transmitter channel, except for the power amplifier (PA), and two paths in each receiver channel, except for the low noise amplifier (LNA).

The invention is applicable for all wireless modulation schemes whether or not they incorporate a form of QFM.

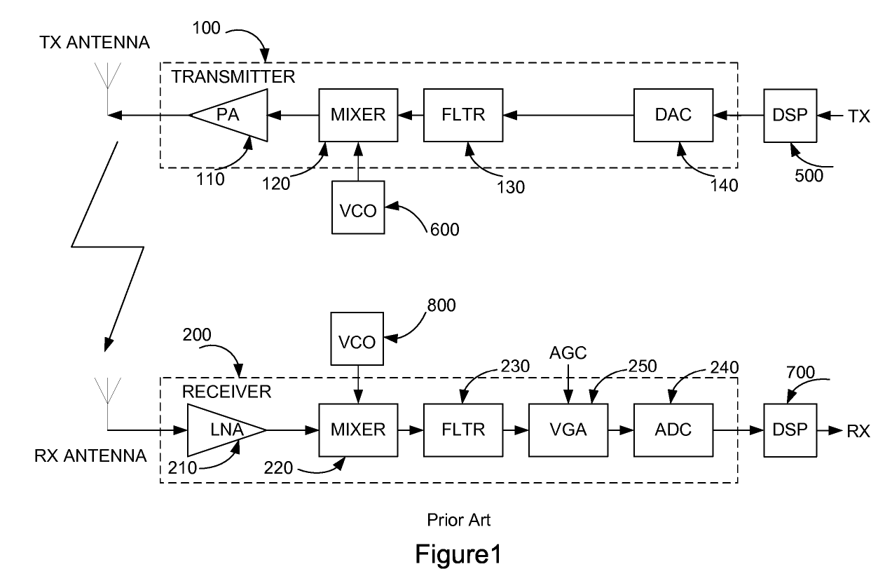

FIG. 1 is a block diagram of a conventional wireless path with single antennas for both the transmitter and receiver ends of the link. In the transmitter channel (TRANSMITTER) 100 a digital signal TX is encoded by a Digital Signal Processor (DSP) 500 and converted to an analog signal through the Digital-to-Analog Converter (DAC) 140. The analog signal passes through a Filter (FLTR) 130, that limits the frequency range of the analog signal to only those frequencies necessary for carrying the wireless information, and is then up-converted to a suitable radio frequency range (RF) using a MIXER 120 and a Voltage Controlled Oscillator (VCO) 600. The MIXER 120 multiplies the analog signal from FLTR 130 with a fixed frequency signal from the VCO 600 to produce the required RF signal. The RF signal passes through the Power Amplifier (PA) 110 and is transmitted from the single transmitter antenna (TX ANTENNA).

The transmitted RF signal is then received by the single receiver antenna (RX ANTENNA) and enters the receiver channel (RECEIVER) 200. The RF signal passes through a Low Noise Amplifier (LNA) 210 and is down-converted, using a MIXER (220) and a VCO (800) to a suitable frequency range for subsequent decoding. The analog signal from the MIXER 220 passes through a filter (FLTR) 230 that limits the frequency range of the analog signal to only those frequencies necessary for carrying the wireless information, then through a variable gain amplifier (VGA) 250 that adjusts the signal to the optimum amplitude for conversion to a digital signal in the analog-to-digital converter (ADC) 240. The resultant signal from the ADC 240 passes through the DSP machine (DSP) 700 to provide the required received digital signal RX.

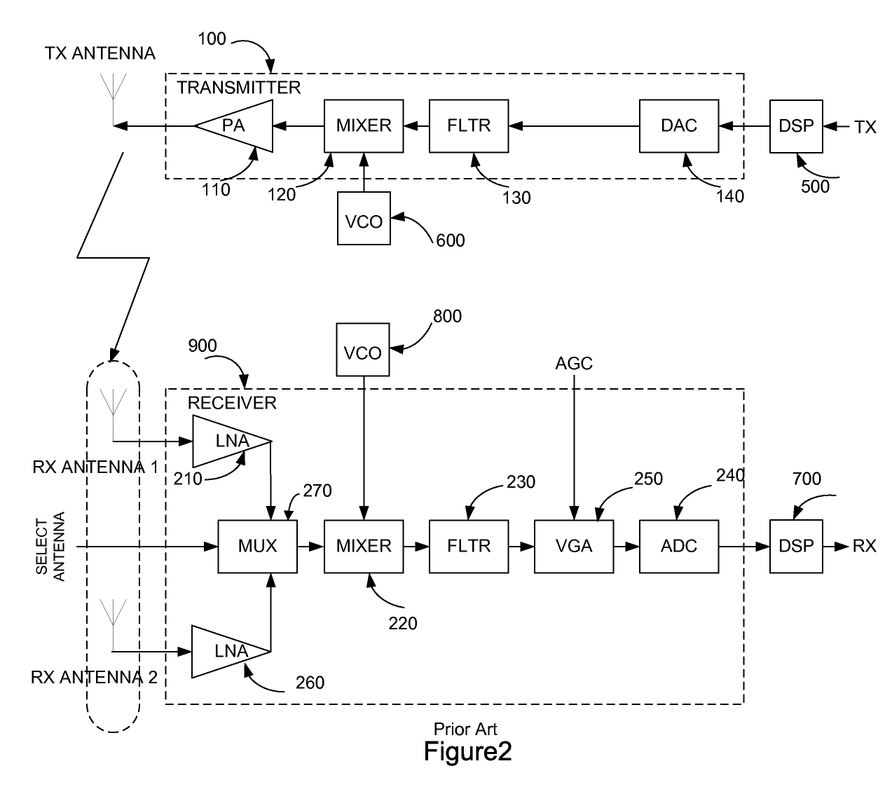

In the wireless link illustrated in FIG. 1 the signal received at the RX ANTENNA can be degraded by several factors such as attenuation due to environmental conditions or path loss due to excessive distances between the TX ANTENNA and RX ANTENNA. In particular, in systems employing high frequency transmissions such as ultra-wide-band (UWB), objects obstructing the line-of-sight between the TX ANTENNA and the RX ANTENNA can cause serious degradation through signal absorption. A conventional wireless system cannot protect against this problem FIG. 2 is a block diagram of a conventional wireless path and illustrating diversity reception. In this illustration a single antenna is used for the transmitter end of the link and two antennas, RX ANTENNA 1 and RX ANTENNA 2, for the receiver end of the link. The transmitter channel operates as explained in FIG. 1 but the receiver channel can accept an RF signal from either of its two antennas. It is typical, but not necessary, for each of the receive antennas to be associated with a separate LNA. In FIG. 2 RX ANTENNA 1 passes its RF signal through LNA 210 and RX ANTENNA 2 passes its signal through LNA 260. The receiver channel RECEIVER 900 now includes two LNA blocks but otherwise performs the same function and includes the same functional blocks as RECEIVER 200 in FIG. 1. It is still a single channel receiver.

In this illustration it is typical for the two receive antennas to have different directionality and for only one to be selected for receiving the RF signal over the wireless link. The receiver channel RECEIVER 900 could then select the antenna with optimum link performance and connect to it following an initial link evaluation routine which compares the signal received at both antennas. This selection is achieved using the multiplexer MUX 270. The preferred link may be a direct line-of-sight or be the result of reflections which bypass an obstructing object so it provides some protection against physical obstructions. However if the signal on the selected antenna degrades significantly then the wireless must perform another link evaluation routine, with possible loss of signal, before normal service can be resumed. This becomes unacceptable in wireless links where obstructing objects may be continuously moving.

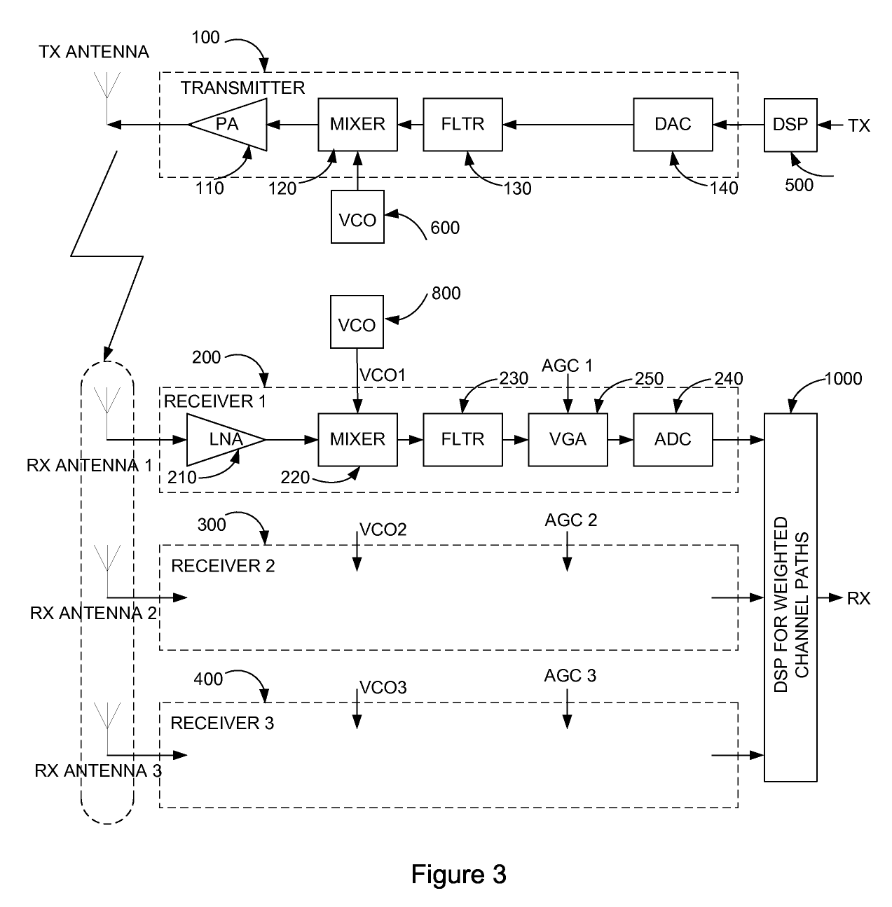

FIG. 3 is a block diagram of a wireless link according to an embodiment of the present invention. In this illustration a single antenna is used for the transmitter end of the link but three antennas, RX ANTENNA 1, RX ANTENNA 2 and RX ANTENNA 3, are employed for the receiver end of the link with each antenna being associated with a separate receiver channel. These receiver channels are RECEIVER 200, RECEIVER 300 and RECEIVER 400. The transmitter channel TRANSMITTER 100 performs the same function as TRANSMITTER 100 in FIG. 1. Each of the receiver channels also performs the same function as RECEIVER 200 in FIG. 1. In FIG. 3 however the signals from all receivers are permanently available and can be continuously monitored and combined in a DSP machine 1000.

Since the signal from each antenna is always available a suitable (DSP) algorithm can dynamically combine all signals to maintain optimum coverage, achieve extended signal range and minimize signal error rate. This is the requirement for IAR (Intelligent Array Radio). To minimize the complexity of the signal processing it is desirable that there should be no frequency offset between the signals in each receiver channel and minimum phase offset. The gain of each channel should also be capable of individual adjustment to allow different weights to be applied to the signals before combining in the DSP. In addition it is also desirable that the gain differences between the channels should track over changes in environmental conditions such as temperature. All these conditions are achieved by integrating the separate receiver channels into a common integrated circuit so the same VCO 800 is used for down-conversion and all components exhibit the same integrated circuit processing characteristics for improved matching. The voltage gain through each receiver channel can then be matched such that they track over temperature as well as being individually adjustable using a variable gain amplifier (VGA) programmed through a suitable interface to the integrated circuit.

A further significant advantage of a wireless receiver using IAR, and constructed onto a single integrated circuit, is that different phase delays, VC01, VC02 and VC03, can be introduced between the VCO 800 and each MIXER in the three receiver channels. By adjusting the individual phase delays in each receiver channel, directionality can be achieved in the reception coverage without physically moving the antennas. The same matched phase delays could also be achieved using a virtual phase shifter in the DSP 1000.This results in increased receiver gain in a particular direction and, conversely, can also reduce gain in an orthogonal direction to reduce eaves-dropping and improve link security.

It is then necessary, as in the present embodiment, to incorporate the receiver channels and the VCO on the same integrated circuit so that the phase delays will track over temperature and manufacturing process spreads.

It is not necessary to include different phase delays and directionality in the present embodiment to achieve significant improvement in wireless link coverage over the current art however it is presented here as a further embodiment of the present invention.

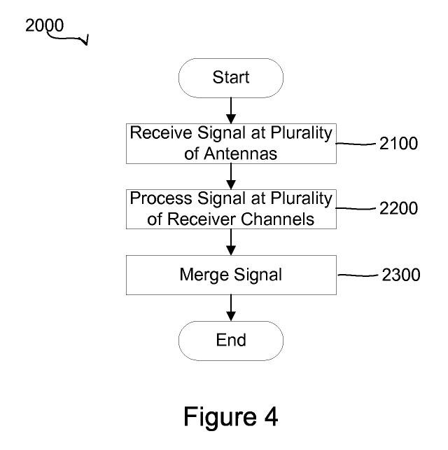

FIG. 4 is a flowchart illustrating a method 2000 of receiving a wireless signal. First, a signal is received (2100) at a plurality of antennas of a receiver. The signal is then processed (2200) by a plurality of receiver channels, as described above. The processed signal is then merged (2300), as described above. The method 2000 then ends.

The foregoing description of the illustrated embodiments of the present invention is by way of example only, and other variations and modifications of the above-described embodiments and methods are possible in light of the foregoing teaching. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A receiver, comprising:
a plurality of antennas, each antenna coupled to a receiver channel, respectively;
a voltage controlled oscillator coupled to the receiver channels; and
a processor coupled to the receiver channels capable of substantially continuously monitoring and merging signals from the receiver channels.

2. The receiver of claim 1, wherein the receiver channels are integrated into a single integrated circuit.

3. The receiver of claim 1, wherein each receiver channel includes an independently adjustable variable gain amplifier.

4. The receiver of claim 3, wherein the variable gain amplifiers adjust directionality of the antennas without physical movement of the antennas.

5. The receiver of claim 1, wherein the voltage controlled oscillator introduces different phase delays to each receiver channel.

6. The receiver of claim 1, wherein the processor includes a virtual phase shifter that introduces different phase delays into each signal received from the receiver channels.

7. A transceiver having a transmitter and the receiver of claim 1.

8. A method, comprising:
receiving a signal at a plurality of antennas, each antenna coupled to a receiver channel, respectively, a voltage controlled oscillator coupled to the receiver channels;
processing the received signals; and
substantially continuously monitoring and merging the processed signals from the receiver channels.

9. The method of claim 8, wherein the receiver channels are integrated into a single integrated circuit.

10. The method of claim 8, wherein each receiver channel includes an independently adjustable variable gain amplifier.

11. The method of claim 10, further comprising adjusting directionality of the antennas without physical movement of the antennas via use of the variable gain amplifiers.

12. The method of claim 8, further comprising introducing different phase delays to each receiver channel.

13. The method of claim 8, further comprising introducing different phase delays into each signal received from the receiver channels after processing by the receiver channels.

14. A system, comprising:
means for receiving a signal at a plurality of antennas, each antenna coupled to a receiver channel, respectively, a voltage controlled oscillator coupled to the receiver channels;
means for processing the received signals; and
means for substantially continuously monitoring and merging the processed signals from the receiver channels.
